(19) United States
(12) Patent Application Publication
(10) Pub. No.: US 2009/0215543 A1
(43) Pub. Date: Aug. 27, 2009

(54) SLIP YOKE WITH INTERNAL SPLINES HAVING PERMANENT COATING AND RELATED METHOD

(75) Inventor: Ronald N. Brissette, Oxford, MI (US)

Correspondence Address: HARNESS, DICKEY & PIERCE, P.L.C., P.O. BOX 828, BLOOMFIELD HILLS, MI, 48303, US

(73) Assignee: AMERICAN AXLE & MANUFACTURING, INC., Detroit, MI (US)

(21) Appl. No.: 12/036,494

(22) Filed: Feb. 25, 2008

(51) Int. Cl. F16C 3/00

(52) U.S. Cl. 464/181

(57) ABSTRACT

A propeller shaft assembly operable to transmit torque between drive wheels and an engine of a vehicle generally includes a first cylindrical tube having a first end and a second end. A first cap is fixedly coupled to the first end. A first yoke is fixedly coupled to the first cap. Internal splines are formed within the second end of the first cylindrical tube. The internal splines define a final internal spline profile established by a permanent polyamide coating fixedly coupled to a metal substrate in the form of an oversized internal spline. The final internal spline profile defines a first layer having a first thickness made of the permanent polyamide coating and a second layer having a second thickness made of the metal substrate. The internal splines are operable to transmit the torque when external splines engage the internal splines by only contacting the first layer made of the permanent polyamide coating.

### FIELD

The present teachings relate to a slip yoke on a propeller shaft for a vehicle and more specifically relate to internal splines on the slip yoke with a permanent polyamide coating that form a spline connection with external splines on a shaft of a transmission, a transfer case or other portions of the propeller shaft.

### BACKGROUND

A propeller shaft can connect a transmission to a differential to provide power from an engine to the drive wheels of a vehicle. Typically, a spline connection can connect the propeller shaft to the transmission so that torque can be transmitted therethrough. The spline connection also permits relative axial motion between the transmission and the propeller shaft.

When the transmission is providing rotational power to the propeller shaft, an axial plunge force required to produce relative axial motion between the propeller shaft and the transmission increases with the amount of torque applied to the spline connection. In some examples, the propeller shaft and/or the transmission can have a nickel plating on each of the splines of the spline connection between the transmission and the propeller shaft. In some instances, the nickel plating can reduce the magnitude of the axial plunge force required to cause the relative axial motion therebetween when the spline connection is unloaded. As the magnitude of the rotary power increases, however, the magnitude of the axial plunge force required to cause the relative motion between the propeller shaft and the transmission is greater with the nickel plating on the splines than in the arrangement with no permanent coating at all on the splines.

When the propeller shaft can not move axially (or is harder to move because of the increased axial plunge force required), the changes in the geometry of the drivetrain due to movement of the vehicle suspension can be absorbed by flexible mounts that secure the engine and the transmission to a body of the vehicle. When rotational power is relieved or reduced, e.g., when the transmission changes from a reverse gear to a forward gear, the drivertrain can settle. At this instance, or when rotational power is reapplied, the drivetrain can produce a sound as components in the drivetrain shift relative to one another as the drivetrain settles.

### SUMMARY

The present teachings generally include a propeller shaft assembly operable to transmit torque between drive wheels and an engine of a vehicle. The propeller shaft assembly generally includes a first cylindrical tube having a first end and a second end. A first cap is fixedly coupled to the first end. A first yoke is fixedly coupled to the first cap. Internal splines are formed within the second end of the first cylindrical tube. The internal splines define a final internal spline profile established by a permanent polyamide coating fixedly coupled to a metal substrate in the form of an oversized internal spline. The final internal spline profile defines a first layer having a first thickness made of the permanent polyamide coating and a second layer having a second thickness made of the metal substrate. The internal splines are operable to transmit the torque when external splines engage the internal splines by only contacting the first layer made of the permanent polyamide coating.

Further areas of applicability will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings.

FIG. 1 is a diagram of an exemplary simplified vehicle having a propeller shaft and transmission in accordance with the present teachings.

FIG. 2 is a partial side view of internal splines that can define a final internal spline profile established by a permanent polyamide coating that is fixedly coupled to oversized internal splines in accordance with the present teachings.

FIG. 3 is a partial side view and cross-sectional view of a propeller shaft having a slip yoke with internal splines with the permanent polyamide coating in accordance with the present teachings.

FIG. 4 is a partial side and cross-sectional view of the propeller shaft connecting to a transmission with a spline connection in accordance with the present teachings.

FIG. 5 is similar to FIG. 4 and shows axial motion between the propeller shaft and the transmission relative to the positioning in FIG. 4 in accordance with the present teachings.

FIG. 6 is a partial side and cross-sectional view of a propeller shaft connecting to a transfer case with a spline connection in accordance with the present teachings.

FIG. 7 is a perspective view of the slip yoke having the internal splines with the permanent polyamide coating of FIG. 3 in accordance with the present teachings.

FIG. 8 is a partial cross-sectional view of FIG. 7 showing the internal splines of the slip yoke with the permanent polyamide coating in accordance with the present teachings.

FIG. 9 is similar to FIG. 8 and shows external splines engaging the permanent polyamide coating on the internal splines of the slip yoke in accordance with the present teachings.

FIG. 10 is a partial cross-sectional view of a multi-piece propeller shaft having a spline connection with internal splines having a permanent polyamide coating that permits axial movement of one portion of the propeller shaft relative to another portion of the propeller shaft in accordance with the present teachings.

FIG. 11 is a diagram of a value of torque versus a value of axial plunge force required to induce axial motion in a spline connection with internal splines having a permanent polyamide coating in accordance with the present teachings relative to traditional nickel plating on the splines or no permanent coating at all.

FIG. 12 is a flowchart showing an exemplary method of forming internal splines that can define the final internal spline profile established by a permanent polyamide coating that is fixedly coupled to oversized internal splines formed of a metal substrate of a tube member in accordance with the present teachings.

### DETAILED DESCRIPTION

The following description is merely exemplary in nature and is not intended to limit the present teachings, their application or uses. It should be understood that throughout the drawings, corresponding reference numerals indicate like or corresponding parts and features.

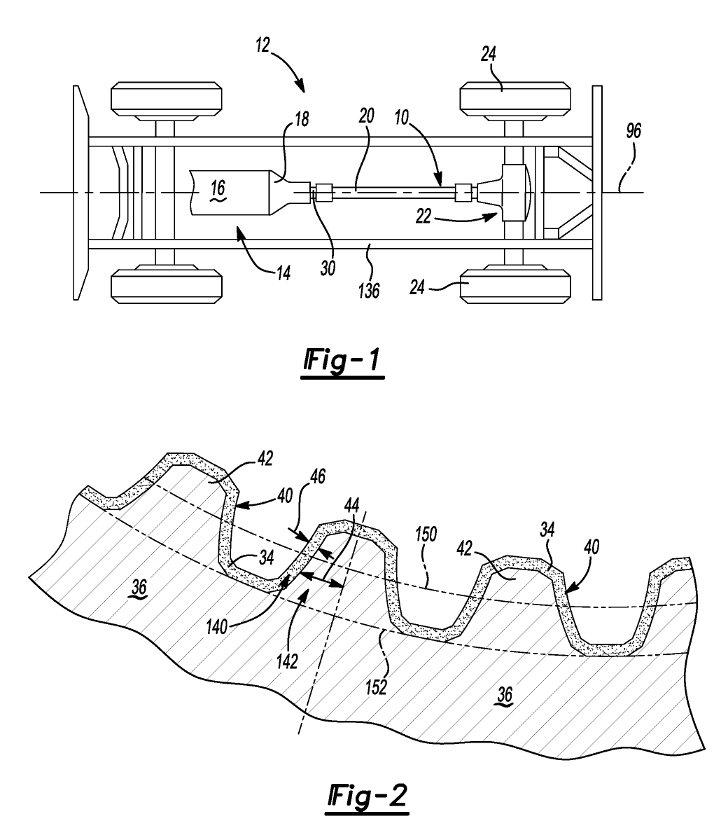

With reference to FIG. 1, a propeller shaft assembly is constructed in accordance with the present teachings and is generally indicated by reference number 10. A vehicle 12 can include a powertrain 14 that can include an engine 16 connected to a transmission 18. The powertrain 14 can also include a drivetrain 20 having the propeller shaft assembly 10 that can connect the transmission 18 to a rear axle 22 to drive a pair of drive wheels 24.

With reference to FIGS. 1, 2 and 3, the propeller shaft assembly 10 can connect to the transmission 18 with a spline connection 30. Unlike the nickel plating example and no permanent coating example discussed above, the propeller shaft assembly 10 can have internal splines 32 that include a permanent polyamide coating 34. With reference to FIG. 2, the permanent polyamide coating 34 can be fixedly coupled to a metal substrate 36 of a cylindrical member 38 to establish a final internal spline profile 40. The final internal spine profile 40 is made up of an oversized internal spline 42 formed from the metal substrate 36 and the permanent polyamide coating 34 fixedly coupled thereto. As such, the final internal spline profile 40 can be established by sizing the permanent polyamide coating 34 and the oversized internal spline 42 formed from the metal substrate 36. More specifically, the final internal spline profile 40 can be configured by adjusting a local thickness 44 of the metal substrate 36, a local thickness 46 of the permanent polyamide coating 34 and a combination of the local thicknesses thereof.

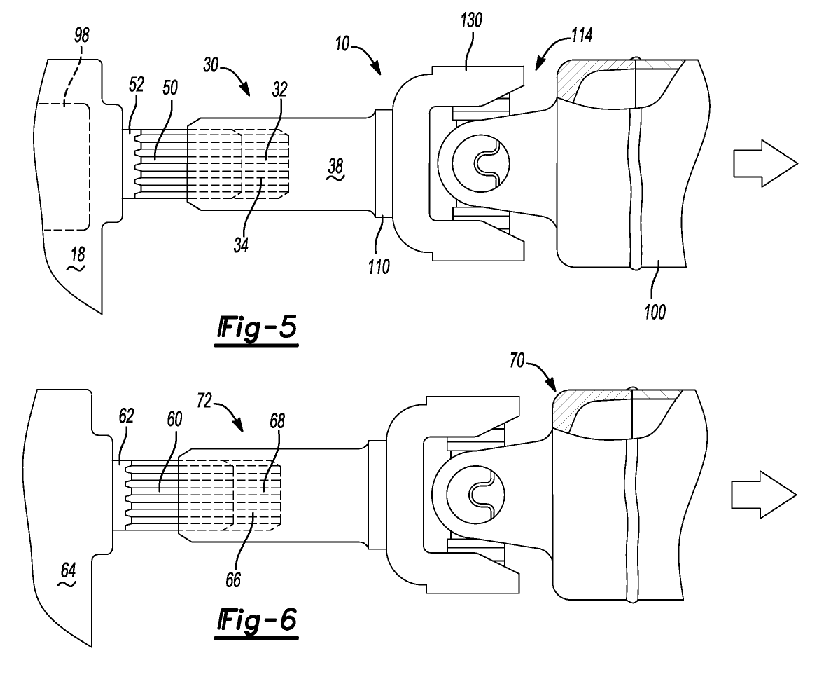

The propeller shaft assembly 10 with the internal splines 32 having the final internal spline profile 40 can receive rotational power through engagement with external splines 50 (FIG. 5) that only contact the permanent polyamide coating 34. In one example and with reference to FIGS. 1, 4 and 5, the external splines 50 can be formed on an output shaft 52 of the transmission 18. The external splines 50 of the output shaft 52 can engage the permanent polyamide coating 34 on the internal splines 32 to form the spline connection 30. In doing so, the transmission 18 is able to transmit rotational power through the propeller shaft assembly 10.

In another example and with reference to FIG. 6, external splines 60 can be formed on an input and/or an output shaft 62 of a transfer case 64. The external splines 60 can engage a permanent polyamide coating 66 on the internal splines 68 of a propeller shaft assembly 70 to form a spline connection 72, which can be similar to the spline connection 30. In doing so, the transfer case 64 can transmit power through the propeller shaft assembly 70.

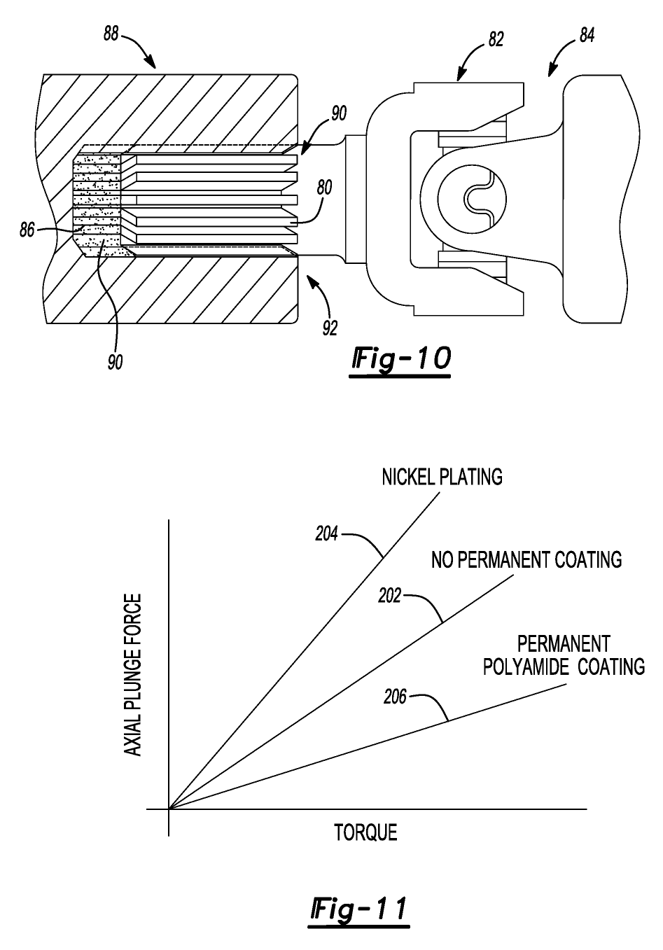

In a further example and with reference to FIG. 10, external splines 80 can be formed on a first portion 82 of a propeller shaft assembly 84. The external splines 80 can engage internal splines 86 of a second portion 88 of the propeller shaft assembly 84 that include the permanent polyamide coating 90. The internal splines 86 with the permanent polyamide coating 90 can engage the external splines 80 to form a spline connection 92 between the portions 82, 88 of the propeller shaft assembly 84. Similar to the spline connection 30, the spline connection 92 can permit relative movement and thus changes in length between the portions 82, 88 of the propeller shaft assembly 84. It will be appreciated in light of the disclosure that multiple spline connections can be implemented on the propeller shaft assembly 84.

In the various examples of the present teachings and with reference to FIG. 1, the engine 16 can be mounted in a transverse or longitudinal orientation along a longitudinal axis 96 of the vehicle 12. The output of the engine 16 can be selectively coupled via a conventional clutch or torque converter to the input of the transmission 18 to transmit rotary power (i.e., drive torque) between the transmission 18 and the drive wheels 24.

With reference to FIGS. 1, 4 and 5, the transmission 18 can include the output shaft 52 and a gear reduction unit 98. The gear reduction unit 98 can be operable for coupling the transmission input (not specifically shown) to the output shaft 52 at various predetermined and selectable gear speed ratios. The propeller shaft assembly 10 can be coupled for rotation with the output shaft 52 of the transmission 18 with the spline connection 30 such that rotational power can be transmitted through the propeller shaft assembly 10 to the rear axle 22 where it can be selectively apportioned in a predetermined manner between the drive wheels 24. It will be appreciated in light of the disclosure that the propeller shaft assembly 10, 70, 84 can be implemented in various examples that can be shown to benefit from the ability to transmit rotational power but also permit relative axial movement therebetween with a relatively reduced axial plunge force necessary to induce the relative axial motion.

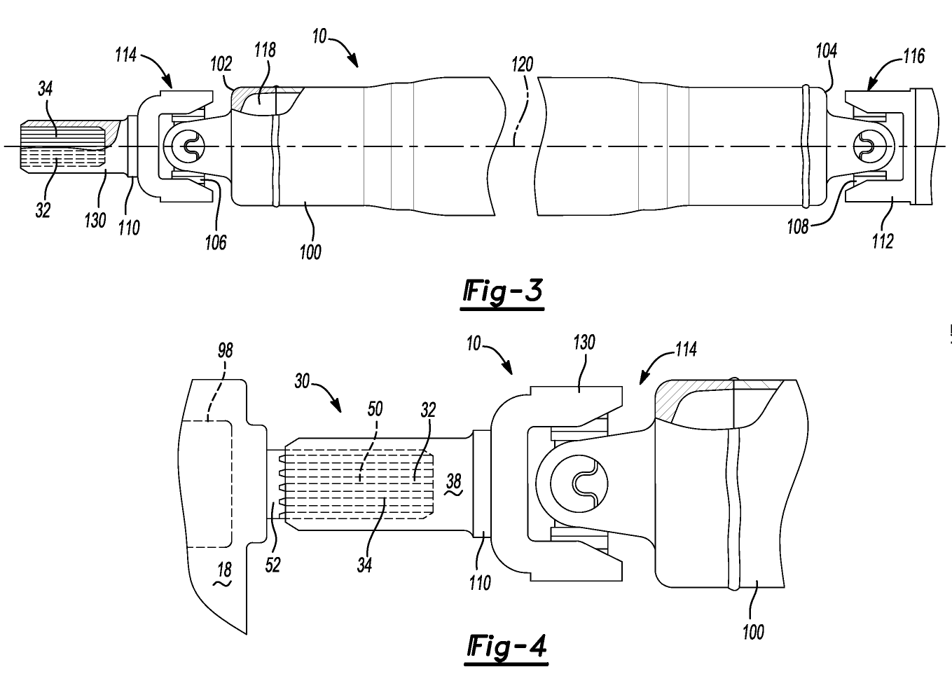

With reference to FIG. 3, the propeller shaft assembly 10 can include a shaft structure 100, first and second trunnion caps 102 and 104, first and second spiders 106 and 108, a yoke assembly 110 and a yoke flange 112. Briefly, the first and second trunnion caps 102 and 104 can be fixedly coupled to opposite ends of the shaft structure 100 typically via a weld. Each of the first and second spiders 106 and 108 can be coupled to the first and second trunnion caps 102, 104 and to the yoke assembly 110 and the yoke flange 112, respectively.

The yoke assembly 110, the first spider 106 and the first trunnion cap 102 can collectively form a first universal joint 114. The yoke flange 112, the second spider 108 and the second trunnion cap 104 can collectively form a second universal joint 116. The shaft structure 100 can have a generally cylindrical shape that defines a hollow central cavity 118 and a longitudinal axis 120. The shaft structure 100 can be preferably formed from a welded seamless material such as aluminum or steel.

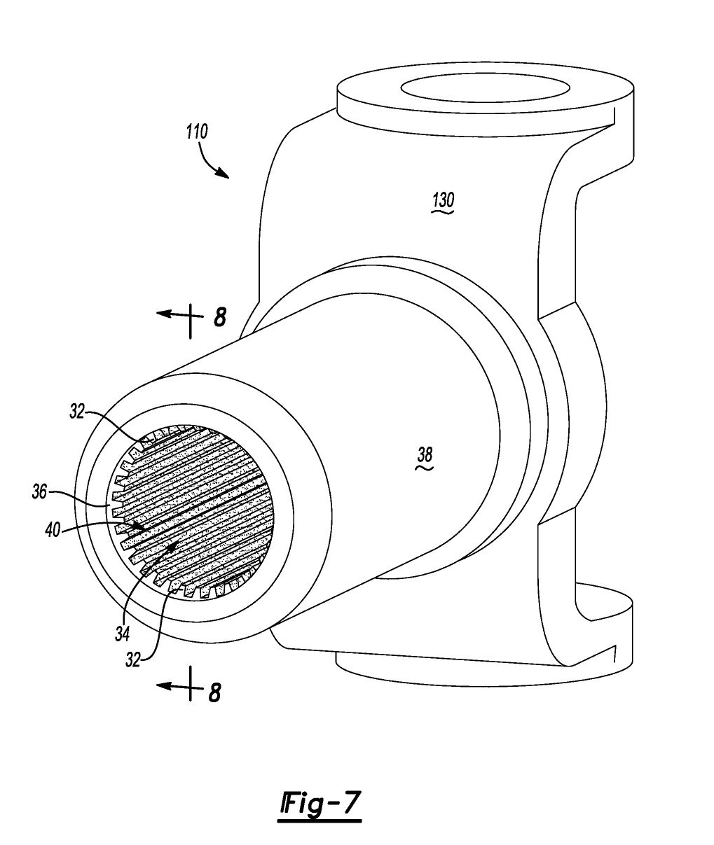

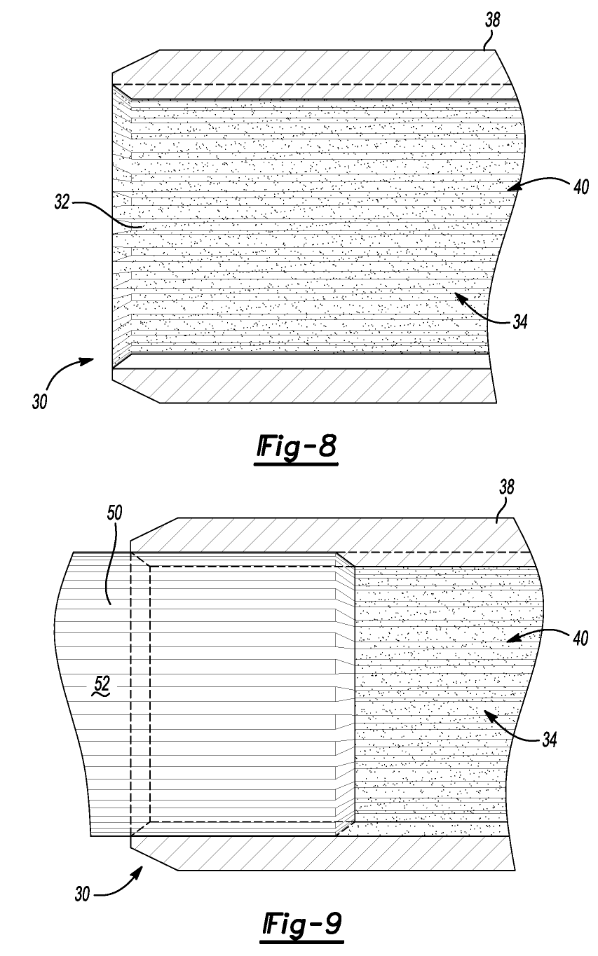

With reference to FIGS. 2, 3 and 7, the yoke assembly 110 can include a slip yoke member 130 that can have the internal splines 32 that extend from an internal surface 132 of a cylindrical portion 134 of the slip yoke member 130. The final internal spline profile 40 of the internal splines 32 can be an involuted spline profile. The internal splines 32 on the slip yoke member 130 can have the final internal spline profile 40 established by the permanent polyamide coating 34 that is attached to the oversized internal spline 42. The internal splines 32 of the slip yoke member 130 can be configured to engage the external splines 50 on the output shaft 52 of the transmission 18 to form the spline connection 30. In doing so, the permanent polyamide coating 34 can contact a surface of the external splines 50 having no permanent coating.

The permanent polyamide coating 34, in addition, can permit the relative axial movement between the propeller shaft assembly 10 and the transmission 18 (or the transfer case 64 or portions 82, 88 of the propeller shaft assembly 84) with reduced axial plunge force necessary to permit such motion. Even when the spline connection 30 experiences an increasing magnitude of torque, the rate of the increase and the magnitude of the axial plunge force required to induce axial movements can be less with the permanent polyamide coating 34 on the internal splines 32 of the spline connection 30 relative to conventional nickel plating of the splines or no permanent coating at all.

In various examples, the vehicle 12 can have suspension components that can connect the drivetrain to a body 136 of the vehicle 12. As the vehicle 12 travels down a road, for example, the suspension components can permit the drivetrain 20 to move relative to the body 136. As the drivetrain 20 moves relative to the body 136, the relative positioning of the components of the drivetrain 20 and the powertrain 14 can change. Furthermore, when the rotational power is relieved or reduced (e.g., the transmission 18 changes from a reverse gear to a forward gear), the drivetrain 20 can settle into an unloaded condition.

The internal splines 32 have the permanent polyamide coating 34 that can establish the final internal spline profile 40 that ultimately defines a clearance fit with the external splines 50. The internal splines 32 with the permanent polyamide coating 34 in the spline connection 30 can be shown to reduce or eliminate sounds (i.e., clunks, etc.) that can be produced when there is relative axial motion between the propeller shaft assembly 10 and the transmission (or transfer case, etc.) especially when rotational power is relieved or reduced. In addition, the internal splines 32 having the permanent polyamide coating 34 can provide the ability to induce axial movement with relatively less axial plunge force, which can be shown to relieve stress on certain engine components such as the transmission 18 and/or one or more engine mounts and, as such, can possibly prolong the life of these components. Moreover, compared to the clunk sound or other less than desirable sounds associated with the conventional splines with nickel plating or no permanent coating at all, the internal splines 32 with the permanent polyamide coating 34 can avoid or substantially reduce sounds from the spline connection 30.

With reference to FIG. 2, the internal splines 32 have the permanent polyamide coating 34 that form the final internal spline profile 40. The final internal spline profile 40 can have a major diameter 150 and a minor diameter 152. The final internal spline profile 40 can be an internal spline involuted profile that can have fillet-root shaped internal splines that can be configured to provide a precise clearance fit to mesh with external splines. The final internal spline profile 40 can be precisely fit by controlling the tooth thickness (e.g., the thickness 44) and/or by controlling the minor diameter 152 of the internal splines 32. By being able to control the fit of the internal splines 32, a clearance fit between the internal splines 32 and the external splines 50 can be maintained to provide minimal axial plunge force required to induce relative axial motion in the spline connection 30 and still retain the ability to dynamically balance the spline connection 30.

In various aspects of the present teachings, the thickness 46 of a first layer 140 made of the permanent polyamide coating 34 can have a minimum thickness of five thousandths (0.005) of an inch (0.0127 mm) per each side of each of the internal splines 32. In one example of the present teachings, the thickness 46 of the first layer 140 made of the permanent polyamide coating 34 can have a thickness of about eight thousandths (0.008) of an inch (0.2202 mm) per each side of each of the internal splines 32. The minimal tooth clearance to provide the clearance fit in the spline connection 30 about one thousandths (0.001) of an inch (0.0127 mm). The spline connection 30, by way of the above example, can include 32 internal spline teeth with the permanent polyamide coating 34. It will be appreciated in light of the present teachings that the first layer 140 made of the permanent polyamide coating 34 fixedly couples to a second layer 142 made of the metal substrate 36 that forms the oversized internal spline 42.

With reference to FIG. 11, a diagram shows exemplary values of torque through a spline connection in accordance with the present teachings relative to the values of the axial plunge force required to induce relative axial movement in the spline connection. As illustrated, as the value of torque at the spline connection increases, the value of axial plunge force required increases to induce relative axial motion in the spline connection. In example 200, there is no permanent coating on the splines of the spline connection. In the example 200, it can be shown that the value of the axial plunge force required to induce relative axial movement in the spline connection 30 can increase as the value of torque increases in a generally one-to-one relationship.

In an example 202, splines of a spline connection are plated with nickel. In the example 202, the axial plunge force required to induce relative axial motion at the spline connection with the nickel plating increases more quickly, as a given amount of torque transmitted through the spline connection 30 increases. In the example 202, the value of the axial plunge force can increase as the value of torque increases in a generally two-to-one relationship. As such, under increased torque the axial plunge force required to induce relative axial motion in the spline connection is greater than the spline connection with no permanent coating attached at all.

In accordance with the present teachings and as shown in example 204, the internal splines 32 having the permanent polyamide coating 34 can permit the axial plunge force required to induce relative motion at the spline connection 30 to increase less quickly, as a given amount of torque transmitted through the spline connection 30 increases. In the example 204, the value of the axial plunge force can increase as the value of torque increases in a generally one-to-two relationship. As such, the internal splines 32 with the permanent polyamide coating 34 can be shown to require less axial plunge force to induce relative axial motion in the spline connection when the internal splines are engaged with the external splines to transmit torque therethrough.

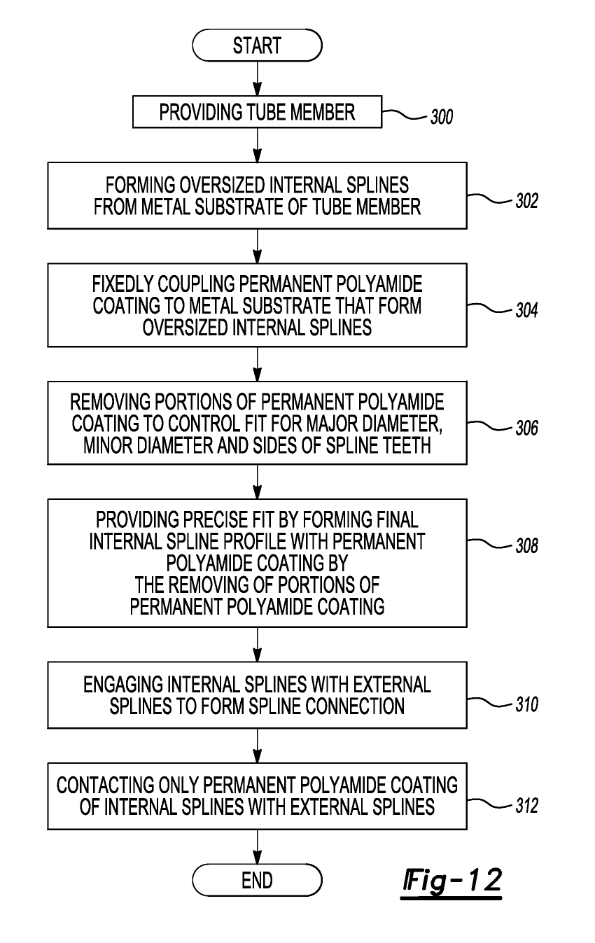

With reference to FIGS. 2 and 12, a method of forming the internal splines 32 having the permanent polyamide coating 34 that provide the final internal spline profile 40 includes providing a tube member at 302. At 304, the oversized internal splines 42 can be formed from the metal substrate 36 of the tube member. At 306, the permanent polyamide coating 34 can be fixedly coupled to the oversized internal splines 42 made of the metal substrate 36.

At 308, relatively small portions of the permanent polyamide coating 34 can be removed with a broach, burr or one or more other appropriate tools to provide a clearance fit for the spline connection 30 by controlling and varying the major diameter of the internal splines 32 (i.e., a major diameter fit), the minor diameter of the internal splines 32 (i.e., a minor diameter fit) and tooth (spline) thickness of the internal spines 32 (i.e., a sides of teeth fit). At 310, a clearance fit is provided so that the permanent polyamide coating 34 of the internal splines 32 are finished with proper tolerances to engage one or more different external splines.

At 312, the internal splines 32 with the permanent polyamide coating 34 can be engaged with external splines to form a spline connection operable to transmit rotational power. At 314, the external splines contact only the permanent polyamide coating 34 that form the first layer 140 of the internal splines 32.

While specific aspects have been described in this specification and illustrated in the drawings, it will be understood by those skilled in the art that various changes can be made and equivalents can be substituted for elements thereof without departing from the scope of the present teachings, as defined in the claims. Furthermore, the mixing and matching of features, elements and/or functions between various aspects of the present teachings may be expressly contemplated herein so that one skilled in the art will appreciate from the present teachings that features, elements and/or functions of one aspect of the present teachings may be incorporated into another aspect, as appropriate, unless described otherwise above. Moreover, many modifications may be made to adapt to a particular situation, configuration or material to the present teachings without departing from the essential scope thereof. Therefore, it is intended that the present teachings not be limited to the particular aspects illustrated by the drawings and described in the specification as the best mode presently contemplated for carrying out the present teachings but that the scope of the present teachings will include many aspects and examples following within the foregoing description and the appended claims.

What is claimed is:

1. A propeller shaft assembly operable to transmit torque between drive wheels and an engine of a vehicle, the propeller shaft assembly comprising:
a first cylindrical tube having a first end and a second end;
a first cap fixedly coupled to said first end;
a first yoke fixedly coupled to said first cap; and
internal splines formed within said second end of said first cylindrical tube, wherein said internal splines define a final internal spline profile established by a permanent polyamide coating fixedly coupled to a metal substrate in the form of an oversized internal spline;
wherein said final internal spline profile defines a first layer having a first thickness made of said permanent polyamide coating and a second layer having a second thickness made of said metal substrate and
wherein said internal splines are operable to transmit the torque when external splines engage said internal splines by only contacting said first layer made of said permanent polyamide coating.

2. The propeller shaft assembly of claim 1, wherein said first layer of said permanent polyamide coating and said second layer of said metal substrate provide internal splines with an involuted profile.

3. The propeller shaft assembly of claim 1, wherein said permanent polyamide coating cannot be wiped off said metal substrate of said first cylindrical tube.

4. The propeller shaft assembly of claim 1 further comprising:
a second cylindrical tube having a first end and a second end;
a second cap coupled to said second end of said second cylindrical tube; and
a second yoke that extends from said second cap and connects to said first yoke to form a first constant velocity joint operable to transmit torque.

5. The propeller shaft assembly of claim 1, wherein the external splines extend from an output shaft of a transmission.

6. The propeller shaft assembly of claim 1, wherein the external splines extend from an output shaft of a transfer case.

7. The propeller shaft assembly of claim 1, wherein the external splines extend from an input shaft of a transfer case.

8. A propeller shaft assembly operable to transmit torque between drive wheels and a transmission connected to an engine of a vehicle, the propeller shaft assembly comprising:
a first tube member having a first end and a second end, wherein said first end is operable to connect to the transmission of the vehicle;
a second tube member having a first end and a second end, wherein said second end of said second cylindrical tube is operable to connect to the drive wheels;
internal splines formed within said second end of said first tube member, wherein said internal splines define a final internal spline profile established by a permanent polyamide coating fixedly coupled to a metal substrate of said first tube member in the form of an oversized internal spline;
external splines formed on said first end of said second tube member,
wherein said final internal spline profile defines a first layer having a first thickness made of said permanent polyamide coating and a second layer having a second thickness made of said metal substrate of said first tube member and
wherein said internal splines are operable to transmit the torque when said external splines engage said internal splines by only contacting said permanent polyamide coating.

9. The propeller shaft assembly of claim 8, wherein said external splines and said internal splines have an involuted profile.

10. The propeller shaft assembly of claim 8, wherein said permanent polyamide coating cannot be wiped off said metal substrate of said first cylindrical tube.

11. A method of forming the internal splines that can engage external splines to form a spline connection operable to transmit rotation power, the method comprising:
providing a first tube member with oversized internal splines formed from a metal substrate of the first tube member;
fixedly coupling a permanent polyamide coating to the oversized internal splines made of the metal substrate;
removing portions of the permanent polyamide coating, wherein removing portions of the permanent polyamide coating includes providing a clearance fit with the external splines by varying at least one of a major diameter, a minor diameter and a thickness of each of the internal splines;
engaging the internal splines with external splines to form the spline connection operable to transmit rotational power, wherein the external splines only contact the permanent polyamide coating of the internal splines.

12. The method of claim 11, wherein removing portions of the permanent polyamide coating includes cutting the permanent polyamide coating with one of a broach and a burr.

13. The method of claim 11, wherein the external splines and the internal splines are provided with an involuted profile.

14. The method of claim 11 further comprising:
fixedly coupling a first cap to a first end of the first tube member;
fixedly coupling a first yoke to the first cap.

15. The method of claim 14 further comprising:
providing a second tube member having a first end and a second end,
fixedly coupling a second cap to the second end of the second tube member;
fixedly coupling a second yoke to the second cap;
connecting the first yoke with the second yoke to form a first constant velocity joint operable to transmit torque.

16. The method of claim 11, wherein the external splines extend from an output shaft of a transmission.

17. The method of claim 11, wherein the external splines extend from an output shaft of a transfer case.

18. The method of claim 11, wherein the external splines extend from an input shaft of a transfer case.
